(19) United States
(12) Patent Application Publication
(10) Pub. No.: US 2003/0137293 A1
(43) Pub. Date: Jul. 24, 2003

(54) Path sensor with an electromagnetic converter element

(76) Inventors: Wolfgang Welsch, Heidelberg (DE); Johannes Meiwes, Markgroeningen (DE); Juergen Boehling, Filderstadt (DE); Zeliko Jaitic, Muenchen (DE)

Correspondence Address: STRIKER, STRIKER & STENBY, 103 East Neck Road, Huntington, NY, 11743, US

(21) Appl. No.: 10/308,462

(22) Filed: Dec. 3, 2002

(30) Foreign Application Priority Data
Jan. 23, 2002 (DE) 102 02 309.3

(51) Int. Cl. G01B 7/30

(52) U.S. Cl. 324/207.2; 324/207.25

(57) ABSTRACT

A path sensor includes at least one electromagnetic converter element (5; 15) and a magnetic circuit having at least one conductance piece (2, 3, 4; 12, 13, 14) and at least one magnet (6; 11). By movement of an element, an effect of the magnetic flux that is measurable by the at least one converter element (5; 15) is effected. The conductance pieces (2, 3, 4; 12, 13) and the converter element (5; 15) are disposed in unchanged positions relative to one another during the path measurement, and a change of a magnetic field that is determinable by the converter element (5; 15) is effected by a movement of the magnet (6; 11) into the measured field. The magnet (6; 11) is polarized in a direction of the measured path (7; 10) in a predetermined area (8; 16) for beginning of an immersion into the measured field, as opposed to adjoining area (9; 17).

### BACKGROUND OF THE INVENTION

The present invention relates to a path sensor with at least one electromagnetic converter element for determining the movement of a component.

From DE 43 17 259 A1, a sensor arrangement for an angle of rotational is already known, in which a magnetic flow generator for producing a measurable magnetic flow is arranged in an electric control unit. Here, electromagnetic converter elements are provided, with which a change of the magnetic flow is detectable by means of the rotational movement of a magnetically conductive body.

With the known electromagnetic converter elements, a measuring effect is utilized, which then arises when the magnetic flux density in the converter elements is changed in dependence on the angle or path. This takes place in practice in that the magnetic circuit is made up of conductance pieces and a permanent magnet. The magnetic conductive conductance pieces and the permanent magnet are rotated relative to one another and thereby, change the flux density on the converter element. This principle leads to undesired secondary effects on the bearing play of the moved components, which likewise, change the fields in the converter elements and, therewith, the measured results.

From DE 197 53 775 A1, it is known that with such a measuring device, with a Hall element as a path sensor, conductance pieces made from magnetically conductive material are used for steering the magnetic flow lines. In practice, the measuring range begins, for example, in an angle sensor in an area of +/−90° with an induction of B=0mT in the Hall element, since the measuring curve often is a symmetrical triangular curve with rounded transitions.

EP 0 670 471 A1 describes an arrangement, in which the entire magnetic circuit is rotated away over the electromagnetic converter. The measuring effect is achieved through the design of the magnet, which has a defined air gap change over the angle of rotation. Here, in principle, larger angles with the same sign of the induction in the Hall element can be measured, however, the measuring range does not begin here with B=0mT in the Hall element, rather in the magnitude of 10% to 20% of the induction Bₘₐₓ with the maximal measured angle.

### SUMMARY OF THE INVENTION

In a further form of a path sensor for determination of movement according to the above-described type with an electromagnetic converter element and a magnetic circuit, the present invention achieves in an advantageous manner that an effect of the magnetic flux that is measurable with the converter element during the movement of an element is thereby effected such that the conductance pieces and the converter element are disposed in an unchanged position relative to one another during the path measurement and the magnet immerses.

The change of the magnetic field that is determinable by the converter element, for example, a Hall element, is affected such that through a movement of the magnet in the measured field, whereby the magnet, according to the present invention, is polarized in the direction of the measured path in a predetermined area for beginning of the immersion in the measured field, as opposed to adjoining areas. Thus, it is unimportant whether a conductance piece, which carries the magnet, turns with this or not; the angular position of this conductance piece has no affect on the magnetic circuit.

With the present invention, therefore, in an advantageous manner, a path sensor is proposed, with which, according to the immersion magnet principle, for example, measured angles of less than 90° are measured, and simultaneously, an angle of impulse with the induction B=0mT is advantageously used, since here, the tolerances, for example, in a Hall element, are at a minimum. With the inventive arrangement, this measuring point is determinable without an additional permanent magnet or another magnetic polarizing potential.

According to a first embodiment, the inventive path sensor is a linear path sensor and the course of the measured path is a straight line. On the other hand, the path sensor can also be a radial path or angle sensor, in which the course of the measured path for measuring of the angle is a circle or a circular section.

### BRIEF DESCRIPTION OF THE DRAWINGS

FIG. 1 shows a path sensor for measurement of a linear path with a magnet, in which a predetermined area is polarized to begin the immersion into the measured field in contrast to adjoining areas; and

FIG. 2 shows a path sensor for a radial path or angle measurement with a magnet, which likewise is polarized in a predetermined area to begin the immersion into the measured field in contrast to adjoining areas.

### DETAILED DESCRIPTION OF THE PREFERRED EMBODIMENTS

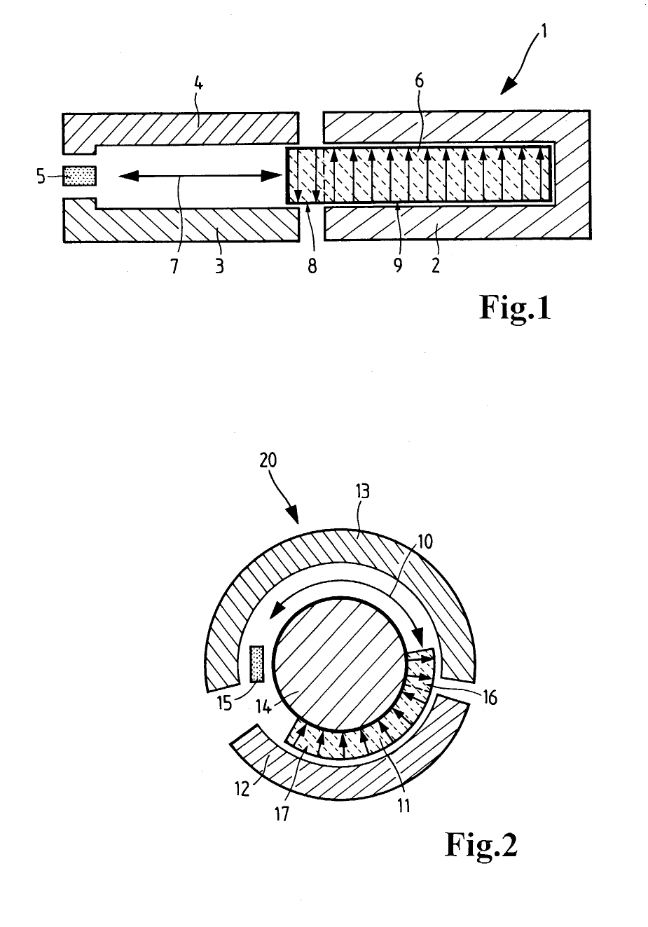

In FIG. 1, a linear path sensor 1 is illustrated, which has a magnetic circuit comprising conductance pieces 2, 3, and 4, made out of iron, for example, a Hall element 5 as an electromagnetic converter element, and a magnet 6, which is immersable according to the immersion magnet principle along a range of measurement 7 in the conductance pieces 3 and 4. By means of a changed induction B in the region of the Hall element 5 by immersion of the magnet 6, a predetermined signal course in the Hall element 5, and therewith, a measured signal for the path measurement, are produced.

According to the present invention, the magnet 6 is polarized in an area 8 on the end, with which it dips at the beginning of the path measurement into the conductance pieces 3 and 4, in contrast to an adjoining area 9, which is designated by corresponding direction arrows for the magnetic field. By means of the change of the polarization direction at the beginning of the range of measurement 7 between the areas 8 and 9 of the magnet 6, the induction B=0mT of the measured area of the Hall element 5 can be used advantageously for a predetermined measuring point.

With the embodiment of FIG. 2, the range of measurement 10 describes a circular path, so that here, a radial path sensor, or an angular sensor 20, is provided. The magnetic circuit is equipped with a magnet 11 and corresponding conductance pieces 12, 13, 14. A Hall element 15 is mounted here at a predetermined position between the conductance pieces 13 and 14, whereby the measuring principle corresponds to that of FIG. 1. The magnet 11 is radially adapted here to the range of measurement, of the measured angle 10, and also here has an area 16 at the beginning of the range of measurement 10, with which the magnet immerses in the conductance pieces 13, 14 at the beginning of the path measurement. This area 15 is also polarized, in contrast to the adjoining area 17, which, likewise, is designated by corresponding direction arrows for the magnetic field.

It will be understood that each of the elements described above, or two or more together, may also find a useful application in other types of constructions differing from the types described above.

While the invention has been illustrated and described herein as a path sensor with an electromagnetic converter element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A path sensor, comprising at least one electromagnetic converter element (5; 15) and a magnetic circuit including at least one conductance piece (2, 3, 4; 12, 13, 14) and at least one magnet (6; 11), wherein by movement of an element, an effect of a magnetic field of the at least one magnet (6; 11) that is measurable with the at least one converter element is effected, wherein at least one of the at least one conductance pieces (2, 3, 4; 12, 13) and the at least one converter element (5; 15) are located relative to one another in an unchanged position during path measurement, wherein the at least one of the at least one conductance pieces and the at least one converter element and the at least one magnet (6; 11) are movable relative to and wherein a change of the magnetic field that is determinable by the at least one converter element (5; 15) is effected by a movement of the magnet (6; 11) in a measured field, wherein the magnet (6; 11) is polarized in a direction of a measured path (7; 10) in a predetermined area (8; 16) for beginning of immersion of the at least one magnet (6; 11) into the measured field, in contrast to an area (9; 17) adjoining said predetermined area (8; 16).

2. Path sensor as defined in claim 1, wherein the path sensor (1) is a linear path sensor and a course of the measured path (7) is a straight line.

3. Path sensor as defined in claim 1, wherein the path sensor (20) is a radial path sensor and a course of the measured path (10) is a circle or a section of a circle.

4. Path sensor as defined in claim 1, wherein the converter element is a Hall element (5; 15).
